(19) United States
(12) Patent Application Publication
(10) Pub. No.: US 2026/0283067 A1
(43) Pub. Date: Sep. 24, 2026

(54) Reversible Rake Assembly

(71) Applicant: Leary Walters, Richmond Hill (CA)

(72) Inventor: Leary Walters, Richmond Hill (CA)

(21) Appl. No.: 19/686,759

(22) Filed: May 24, 2026

(51) Int. Cl. A01D 7/00; B25G 1/06; B25G 3/38

(52) U.S. Cl. CPC A01D 7/00; B25G 1/06; B25G 3/38

(57) ABSTRACT

A reversible rake assembly includes a rake head, a handle pivotably connected to the rake head, and a brace member attached approximately mid-shaft of the handle. The brace member includes a brace opening configured to receive a removable pin. The pin extends into a pin receiving opening formed in the rake head to selectively secure the handle relative to the rake head in different operating positions. The rake assembly is configurable between a normal raking position and a push position. A pressure arm positioned near a lower portion of the handle adjacent the pivot connection assists in applying downward force during pushing operations. In the illustrated embodiment, the pressure arm includes a generally T-shaped configuration, although other configurations may be used. A wheel may be positioned adjacent the rake head to facilitate movement across a ground surface.

### CROSS-REFERENCE TO RELATED APPLICATIONS

This application claims the benefit of previously filed provisional applications, if any.

### FIELD OF THE INVENTION

The present invention relates generally to lawn and garden tools and, more particularly, to a reversible rake assembly selectively configurable between a normal raking position and a push position.

### BACKGROUND OF THE INVENTION

Conventional leaf rakes are generally configured for pulling leaves and debris toward a user. Such rakes are often physically tiring during prolonged use. Pulling leaves and debris toward a user may place repetitive strain on the arms, shoulders, and back.

Conventional rakes are also generally inefficient for pushing leaves, grass clippings, and lightweight debris across a surface. Existing push-style tools may require separate devices, bulky structures, or complicated attachments.

Accordingly, a need exists for an improved reversible rake assembly capable of operating in both a conventional raking configuration and a push configuration while maintaining a relatively lightweight and simple structure.

### SUMMARY OF THE INVENTION

The present invention provides a reversible rake assembly including a handle pivotably connected to a rake head. A brace member attached approximately mid-shaft of the handle selectively secures the handle relative to the rake head through use of a removable pin.

In a first configuration, the rake assembly operates in a normal raking position suitable for pulling leaves and debris toward a user.

In a second configuration, the rake assembly operates in a push position suitable for pushing leaves and debris away from a user.

The push configuration may provide a more efficient and less physically demanding method for moving leaves, grass clippings, and debris across a surface.

A pressure arm positioned near a lower portion of the handle adjacent the pivot connection assists in applying downward force during pushing operations.

In the illustrated embodiment, the pressure arm includes a generally T-shaped configuration. However, the pressure arm is not limited to the illustrated configuration and may include other shapes, widths, angular orientations, contours, extensions, or support structures.

The assembly may further include a wheel positioned near a forward portion of the rake head to facilitate movement across a ground surface.

### BRIEF DESCRIPTION OF THE DRAWINGS

FIG. 1 illustrates a perspective view of the rake assembly in a normal raking position.

FIG. 2 illustrates a perspective view of the rake assembly in a push position.

FIG. 3 illustrates an enlarged detail view showing insertion of the pin into the rake head.

### Reference Numerals

10—Handle
20—Rake head
22—Tines
30—Wheel
40—Pivot connection
50—Pin
52—Brace member
54—Brace opening
56—Pin receiving opening
60—Pressure arm

### DETAILED DESCRIPTION OF THE INVENTION

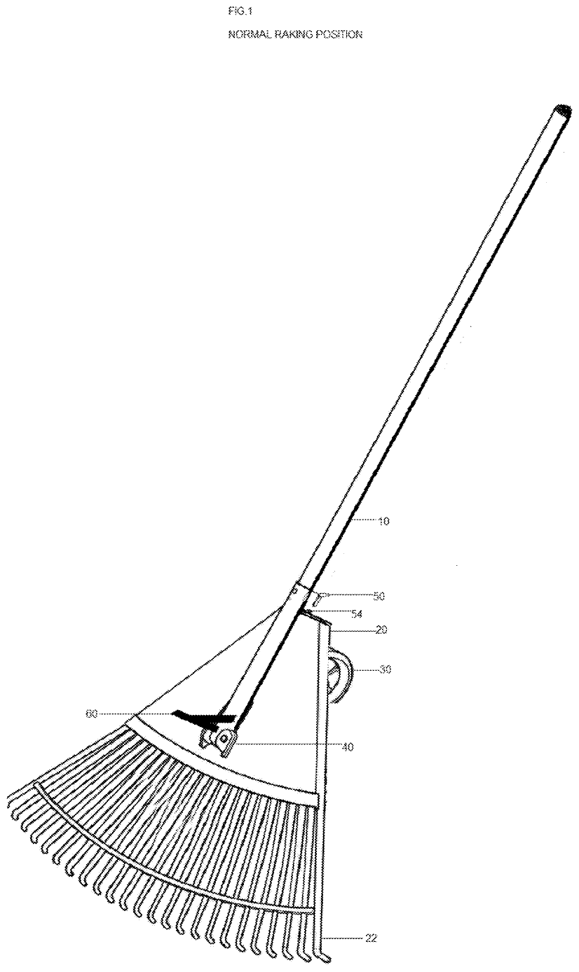

Referring initially to FIG. 1, a rake assembly includes a handle 10 connected to a rake head 20. The rake head 20 includes a plurality of tines 22 extending outwardly for engaging leaves, grass, and other debris.

The handle 10 is pivotably connected to the rake head 20 through a pivot connection 40. The pivot connection 40 permits selective angular adjustment of the handle 10 relative to the rake head 20.

A brace member 52 attached approximately mid-shaft of the handle 10 includes a brace opening 54 configured to receive a removable pin 50.

The rake head 20 further includes a pin receiving opening 56 positioned to align with the brace opening 54 when the rake assembly is positioned in a selected operating configuration.

Insertion of the pin 50 through the brace opening 54 and into the pin receiving opening 56 secures the handle 10 relative to the rake head 20.

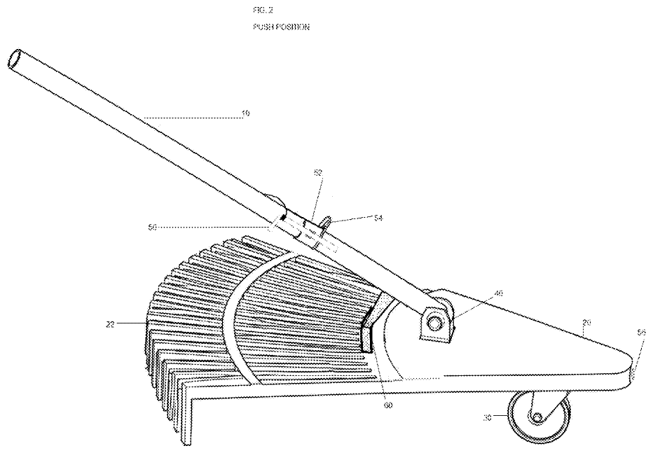

In the configuration illustrated in FIG. 1, the rake assembly is positioned in a normal raking position suitable for pulling debris toward a user.
Referring to FIG. 2, the handle 10 may be repositioned relative to the rake head 20 to define a push position. In this configuration, the rake assembly may be used to push leaves, grass clippings, or debris across a surface.

The push position may provide a more efficient and less physically demanding method for moving debris compared to conventional pulling-only rake configurations.

A pressure arm 60 is positioned near a lower portion of the handle 10 adjacent the pivot connection 40. The pressure arm 60 extends generally parallel to the handle 10 and assists in applying downward force during pushing operations.

In the illustrated embodiment, the pressure arm 60 includes a generally T-shaped configuration. However, the pressure arm 60 is not limited to the illustrated configuration and may include other shapes, widths, angular orientations, contours, extensions, or support structures.

A wheel 30 may be positioned near a forward portion of the rake head 20 to facilitate movement across a ground surface.

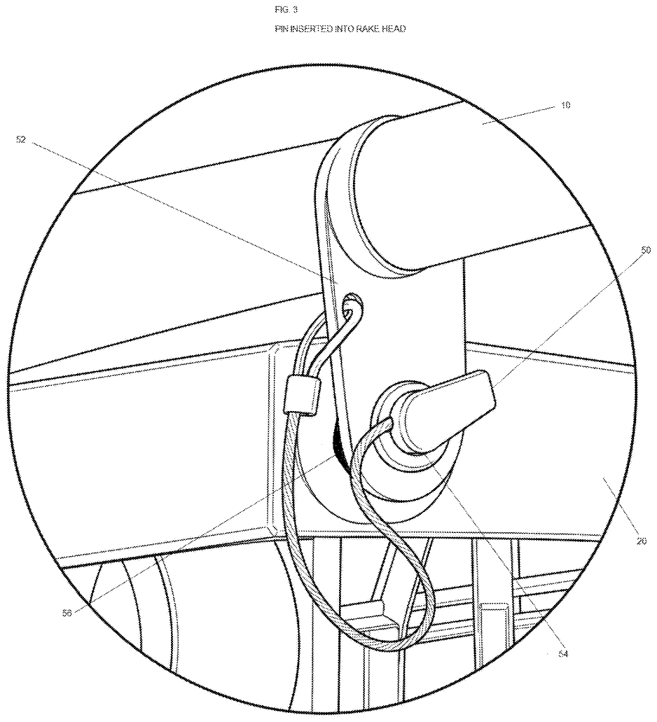

Referring to FIG. 3, the pin 50 is shown inserted through the brace opening 54 and into the pin receiving opening 56 formed in the rake head 20.

The illustrated embodiments are exemplary only, and variations in dimensions, materials, angular orientations, attachment configurations, and structural arrangements may be made without departing from the scope of the invention.

1. A reversible rake assembly comprising: a rake head; a handle pivotably connected to the rake head; a brace member attached approximately mid-shaft of the handle, the brace member including a brace opening; a pin configured to extend through the brace opening and into a pin receiving opening formed in the rake head to selectively secure the handle relative to the rake head; and a pressure arm positioned near a lower portion of the handle adjacent the pivot connection.

2. The rake assembly of claim 1, further comprising a wheel coupled to the rake head.

3. The rake assembly of claim 1, wherein the handle is movable between a normal raking position and a push position.

4. The rake assembly of claim 1, wherein the pressure arm extends generally parallel to the handle.

5. The rake assembly of claim 1, wherein the pin is removable to permit repositioning of the handle relative to the rake head.
